(19) United States
(12) Patent Application Publication
(10) Pub. No.: US 2020/0324397 A1
(43) Pub. Date: Oct. 15, 2020

(54) METHOD FOR SCREWING IN A SCREW TO A PREDETERMINED TIGHTENING TORQUE

(71) Applicant: STIWA Holding GmbH, Attnang-Puchheim (AT)

(72) Inventors: Matthias BRUNNER, Voecklabruck (AT); Tobias GLUECK, Wien (AT); August GRUENDL, Schoerfling (AT); Andreas KUGI, Wien (AT); Josef MEINGASSNER, Hohenzell (AT); Michael PAUDITZ, Schwanenstadt (AT)

(73) Assignee: STIWA Holding GmbH, Attnang-Puchheim (AT)

(21) Appl. No.: 16/305,557

(22) PCT Filed: May 31, 2017
(86) PCT No.: PCT/AT2017/060142

§ 371 Date: Nov. 29, 2018

(30) Foreign Application Priority Data
Jun. 1, 2016 (AT) A 50501/2016

(51) Int. Cl. B25B 21/00; B23P 19/06; B25B 23/147

(52) U.S. Cl. CPC B25B 21/008; B25B 23/1475; B23P 19/066

(57) ABSTRACT

The invention relates to a method for driving a screw (4) with a predetermined tightening torque by means of a screwdriving tool (3), which is coupled with an electric motor (2), which is activated by a regulation (8). The method comprises the following method steps:
acceleration of the electric motor (2) in screwing-in direction (15) to a predetermined maximum rotational speed,
operation of the electric motor (2) at maximum rotational speed until a drive shaft (11) of the electric motor (2) has completed a specified number of spindle revolutions,
reduction of the rotational speed of the electric motor (2) to a predetermined reduced rotational speed;
operation of the electric motor (2) at reduced speed until a torque increase that exceeds a predetermined threshold value is detected by a measuring unit (14) connected downstream from the electric motor (2);
subsequent turning of the screw (4) or nut until the predetermined tightening torque is reached.

The invention relates to a method for driving a screw or nut with a predetermined tightening torque.

Various methods for establishment of a screwed joint between two structural parts are known from the prior art. The methods known from the prior art relate in particular to fabrication systems in which screws or nuts are driven into the respective mating thread associated with the screw or nut by means of a tool coupled with an electric motor, in order to fasten a structural part. In the process, the screws or nuts must be tightened with a predetermined tightening torque, wherein the tightening torque to be attained has only a narrow tolerance range.

The methods known from the prior art have the disadvantage that, for achievement of the required tightening torque in compliance with the required tolerance range, the screwdriving speed must be chosen to be correspondingly low, in order to suppress dynamic effects that occur due to the mass inertia of the drive train and falsify the tightening torque.

The task of the present invention was to overcome the disadvantages of the prior art and to provide a method that has an increased process speed with simultaneous maintenance of the process accuracy.

This task is accomplished by a method according to claim 1.

According to the invention, a method is provided for driving a screw or nut with a predetermined tightening torque by means of a screwdriving tool, which is coupled with an electric motor. The electric motor is activated by a compensation. The method comprises the following method steps:
establishment of a torque-transmitting connection between screwdriving tool and screw or nut;
acceleration of the electric motor in screwing-in direction to a predetermined maximum rotational speed,
operation of the electric motor at maximum rotational speed until a drive shaft of the electric motor has completed a specified number of spindle revolutions, wherein the screw or nut is being driven freely into the respective mating thread during this method step or the mating thread is being cut by means of the screw;
reduction of the rotational speed of the electric motor to a predetermined reduced rotational speed;
operation of the electric motor at reduced rotational speed until a torque increase that exceeds a predetermined threshold value is detected, preferably by a measuring unit connected downstream from the electric motor, wherein the torque increase occurs when the screw or nut comes into contact with its shoulder on the structural part to be fastened;
subsequent turning of the screw or nut until the predetermined tightening torque is reached.

One advantage of the method according to the invention lies in the fact that the method is subdivided into the most diverse method steps, wherein the electric motor has a different speed in the individual method steps. By this measure, it is ensured that the screwdriving time may be shortened as much as possible and simultaneously the required tightening torque can be reached as accurately as possible. Particularly during operation of the electric motor at a specified maximum speed, a driving of the screw as rapidly as possible is ensured. In this method step, the screw is driven into the corresponding mating thread, wherein care is taken that the screw is driven freely into the thread and the shoulder does not yet bear on the structural part to be fastened. Alternatively to free driving of the screw into a mating thread, it may also be provided that the mating thread is formed by the screw. Even here, the torque to be applied is considerably smaller than is the case upon contact of the shoulder of the screw. Only in the subsequent method step, in which the electric motor is operated at reduced rotational speed, is it provided that the shoulder of the screw makes contact on the structural part to be fastened. This contact of the shoulder of the screw on the structural part to be fastened has a torque increase as a consequence. This torque increase may be detected directly, for example by sensing of the motor current in the electric motor.

Alternatively, it is also possible that the torque increase is detected by a measuring unit connected downstream from the electric motor, which measuring unit is designed for sensing of the torque, for example in the form of a torque-measuring shaft.

Furthermore, it may be expedient when the electric motor is braked to a predetermined minimum rotational speed after the detection of the torque increase. In the process, it is of advantage that overtightening of the screw can be avoided by braking of the electric motor to minimum speed.

Furthermore, it may be provided that the electric motor is operated at minimum rotational speed for a predetermined or predeterminable time period, until vibrations that occur in the drive system due to the process of braking from the reduced rotational speed to the minimum rotational speed have largely died away. It is of advantage in this connection that, due to the operation of the electric motor at the minimum rotational speed in a predetermined time period, it can be ensured that the drive system is able to cease vibrating, and so no falsification of the measured torque occurs at the measuring unit. In extreme cases, it may be necessary that complete stoppage is chosen as the minimum rotational speed. The vibrations that die away must develop on the basis of the mass inertia or of the inertial forces of the individual components in the drive system and on the basis of the abrupt braking maneuver.

Beyond this, it may be provided that, after passage of the predetermined time period during which the electric motor is operated at minimum speed, the further activation of the electric motor is specified by the regulation on the basis of the torque measured in the measuring unit. The predetermined time period can be reset individually for each cycle. After passage of this predetermined time period, during which the sensor signal is falsified, it is possible to change over to torque regulation, in order to be able to reach the required tightening torque.

A manifestation is also advantageous in which it may be provided that the reduced rotational speed amounts to between 0.1% and 100%, especially between 0.5% and 99%, preferably between 50% and 80% of the maximum rotational speed. It is then of advantage that, during operation of the electric motor at reduced rotational speed, a torque that exceeds a predetermined threshold value can be detected and, on the basis of the reduced rotational speed, sufficient time then remains in order to lower the rotational speed further and to set the required torque.

According to a further development, it is possible that, directly after the detection of the torque increase, the further activation of the electric motor by the compensation is specified on the basis of a torque value, wherein the electric motor is braked to a predetermined minimum rotational speed after the detection of the torque increase and, in an initial period during the braking process, the torque sensed in the measuring unit is cross-faded by a torque based on a model calculation and, after the initial period, the torque detected by the measuring unit is used as the input variable for the regulation. This alternative variant has the advantage that the process time can be further shortened and optimized. Due to the cross-fading of the sensed torque with a torque based on a model calculation, the measurement error that occurs because of the vibration of the system after the process of braking of the electric motor can be compensated.

Furthermore, it may be provided that, directly after the detection of the torque increase, the further activation of the electric motor is specified by the regulation on the basis of a target trajectory of the torque value, wherein the rotational speed variation is calculated from the target trajectory of the torque value in a pilot control. If a disturbance-variable monitor is used, it is possible to estimate the torque actually acting on the screw. By cross-fading to this estimated torque, disturbances can be blanked out.

Furthermore, it may be provided that, in a first phase after the detection of the torque increase, the torque value is estimated by means of a disturbance-variable monitor and that, in a second phase after detection of the torque increase, the torque value is detected directly by the measuring unit and used as the input variable for the compensation. By specification of the torque value by means of the disturbance-value monitor, vibrations or disturbances in the system can be filtered, so that no vibrating occurs in the compensation. After the dying away of the vibrations, the torque actually measured at the measuring unit may then be used as the input value for the compensation.

Furthermore, it may be provided that the transition between various rotational speeds of the individual method steps is specified in such a way that no sudden increases of the acceleration occur. Due to the avoidance of sudden increases in the acceleration, the jolt that acts on the individual structural parts of the screwdriver is reduced and thereby the longevity of the screwdriver is increased.

Furthermore, it may be expedient when, in the model calculation, the mass inertia and/or the spring stiffness and/or the damping and the angular accelerations of the individual structural parts built into the drive train are taken into consideration. In this connection, it is of advantage that, on the basis of these values or on the basis of these variables of state, the dynamic behavior of the drive train can be calculated exactly and thereby a falsification of the measured torque during braking or during acceleration of the electric motor can be compensated.

Beyond this, it may be provided that the model calculation is adapted on the basis of the respective preceding cycles in an iterative learning process, wherein the time variation of the measured value of the torque in the measuring unit as well as of the motor torque and of the associated angle of rotation of the drive shaft in the electric motor is used for adaptation of the model calculation. In this connection, it is of advantage that the drive process can be adapted and improved during the ongoing operation, whereby the accuracy for attainment of the tightening torque can be increased on the one hand and beyond that the process time can be further shortened.

Moreover, it is possible to provide that the regulation circuit is expanded by a pilot control for force and/or inertia compensation, should the dynamic response of the subordinate regulator not be sufficient. The pilot controls may be derived on the basis of the mathematical model. It may be sufficient to use, for this, a greatly simplified model, such as a pure rigid-body system, which considers only the moments of inertia and no dynamic elements. Alternatively to this, it is possible to use a dynamic system, such as described in this document, for construction of the mathematical model.

Furthermore, it may be provided that a disturbance-value monitor, especially a Kalman filter, is used for the model calculation, wherein regulation also takes place in the first step and cross-fading to the torque detected in the measuring unit takes place only from a certain point in time onward. In this connection, it is of advantage that such a disturbance-variable monitor is able to compare the actually existing actual values with the output variables determined from the model and is able to specify an external torque on the compensation as the output value, whereby the accuracy for attainment of the tightening torque can be improved.

According to a particular manifestation, it is possible to dispose, between electric motor and screwdriving tool, a gearbox, by means of which the rotational speed or the torque between electric motor and screwdriving tool is stepped up. In this connection, it is of advantage that the torque of the electric motor can be stepped up by the gearbox, wherein only a small motor torque is sufficient in order that a sufficient torque can be applied on the screw. In the same way, it is ensured by the gearbox that the accuracy of resolution of the motor can be improved by the gearbox by virtue of the step-up ratio.

Where a screw is mentioned in this document, it means not only a screw but additionally all fastening means that have a thread and are used for clamping of a structural part by screwdriving. For example, they also include nuts, wherein these also have a shoulder that is able to bear on a structural part to be fastened. A corresponding mating thread for a screw is a threaded hole or a nut. For screws with self-cutting threads, the associated mating hole may be a simple hole, which does not have any thread, since the thread is cut directly by the screw. A corresponding mating thread for a nut is a screw or a threaded pin.

The maximum rotational speed to which the electric motor is accelerated does not necessarily have to correspond to the maximum possible rotational speed of the electric motor. To the contrary, it is also possible that the maximum rotational speed is obtained on the basis of the process parameters and is a computationally determined value. In this connection, the specified maximum rotational speed may vary from one screwdriving process to the next.

The threshold value of the torque that is detected may be a specified or individually specifiable absolute value of the torque, for example in Nm.

Alternatively to this, it is also possible that not an absolute value of the torque is specified as the threshold value but instead a specified or individually specifiable torque increase per unit angle of rotation of the motor is specified as the threshold value. This threshold value of the torque increase may be defined, for example in Nm per ° of angle of rotation.

In yet another embodiment variant, it is conceivable that a maximum change of the torque increase per unit angle of rotation of the screw is specified as the threshold value. This maximum change of the torque increase per unit angle of rotation may be calculated, for example, by the first derivative of the function of the torque increase per unit angle of rotation of the motor. This threshold value of the change of the torque increase may be defined, for example, in ΔNm per Δ° of angle of rotation.

As regulation within the meaning of this document, a regulation having two-degrees of freedom and with subordinate motor regulation may be understood, wherein a regulating circuit containing this regulation may also be provided with additional pilot controls.

Furthermore, it may be provided that an rotational speed variation is calculated on the basis of the load characteristic and of a desired target trajectory for the external torque. This speed is linked into the reduced rotational speed and is transitioned into the stoppage. With this rotational speed profile, it is ensured that the external torque follows the desired target trajectory sufficiently well. Thereby it is possible to compensate the remaining regulation deviation subsequently with a linear regulator R_{M}. If a disturbance-variable monitor is used, regulation to the estimated signal takes place and, at the end of the trajectory, cross-fading to the measured signal takes place. If the disturbance-variable monitor is not present, because the quality of the measured signal is sufficiently good, then regulation directly to the measured signal takes place and thereby also no cross-fading is performed.

For better understanding of the invention, it will be explained in more detail on the basis of the following figures.

Therein, respectively in greatly simplified schematic diagrams:

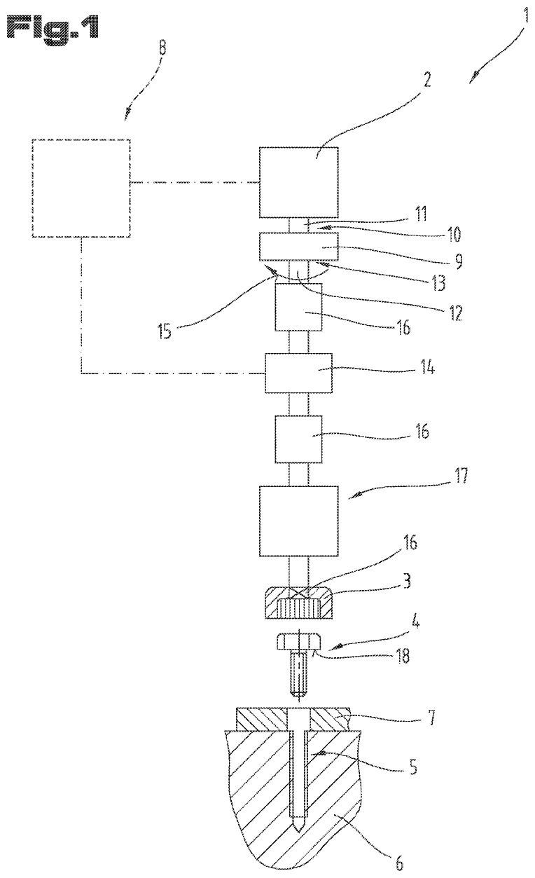

FIG. 1 shows a schematic diagram of one possible construction of a screwdriver;

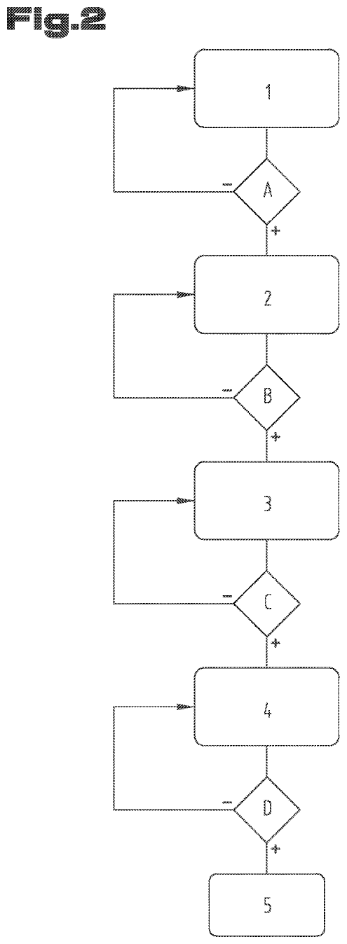

FIG. 2 shows a flow diagram of a first regulation strategy for driving a screw;

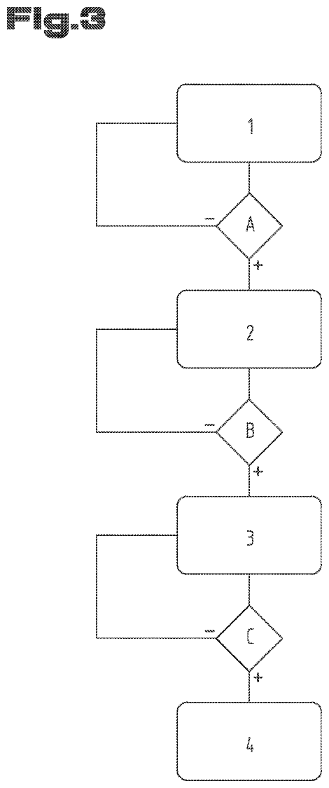

FIG. 3 shows a flow diagram of a second regulation strategy for driving a screw;

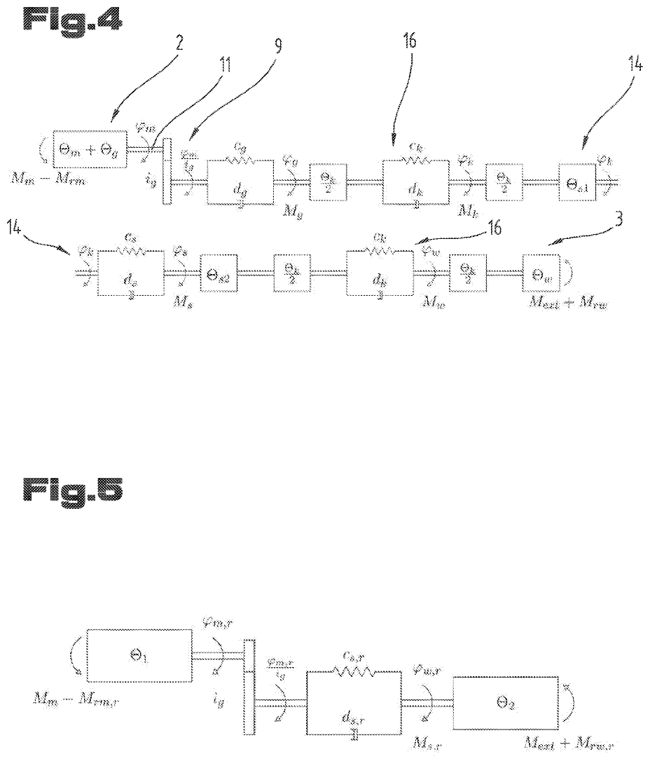

FIG. 4 shows a structural circuit diagram of the mechanical model of the screwdriver;

FIG. 5 shows a simplified structural circuit diagram of the mechanical model of the screwdriver;

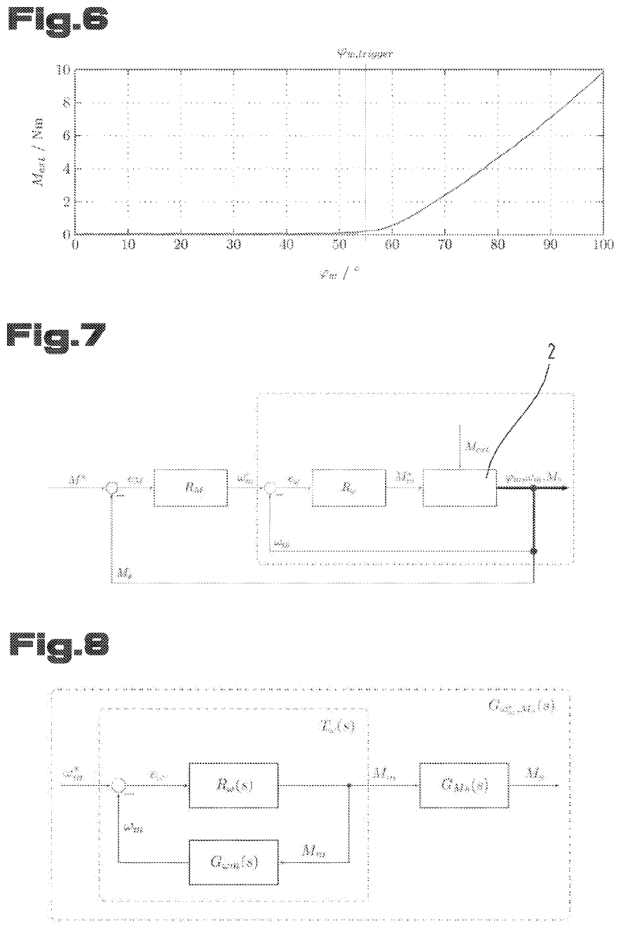

FIG. 6 shows an exemplary variation of the external torque;

FIG. 7 shows a structural circuit diagram of a regulation circuit for the torque regulation;

FIG. 8 shows an exemplary regulation section of a torque regulation;

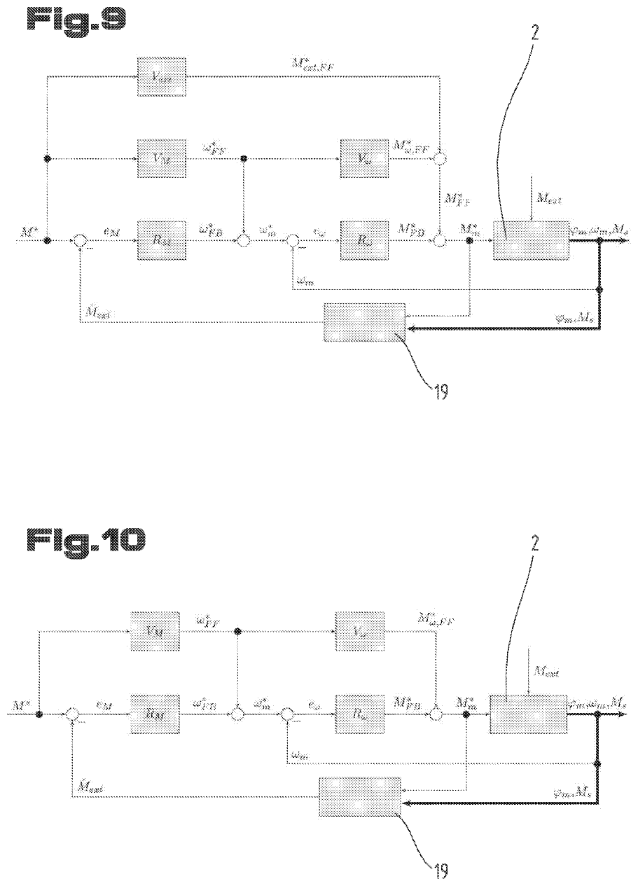

FIG. 9 shows a structural circuit diagram of a regulation circuit with disturbance-variable monitor and load pilot control, torque pilot control as well as inertia compensation;

FIG. 10 shows a structural circuit diagram of a regulation circuit with disturbance-variable monitor and torque pilot control as well as inertia compensation;

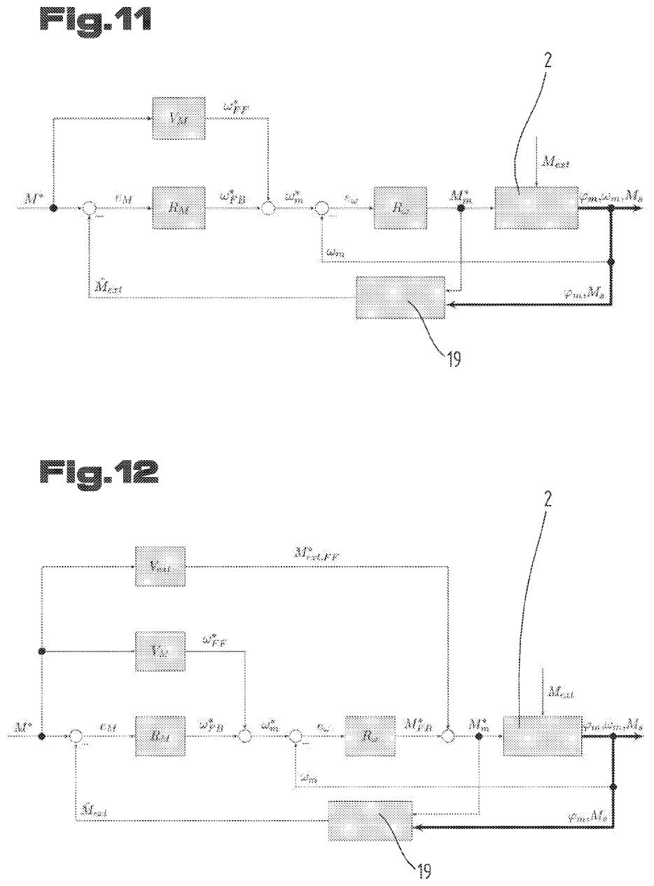

FIG. 11 shows a structural circuit diagram of a regulation circuit with disturbance-variable monitor and torque pilot control;

FIG. 12 shows a structural circuit diagram of a regulation circuit with disturbance-variable monitor and load pilot control as well as torque pilot control;

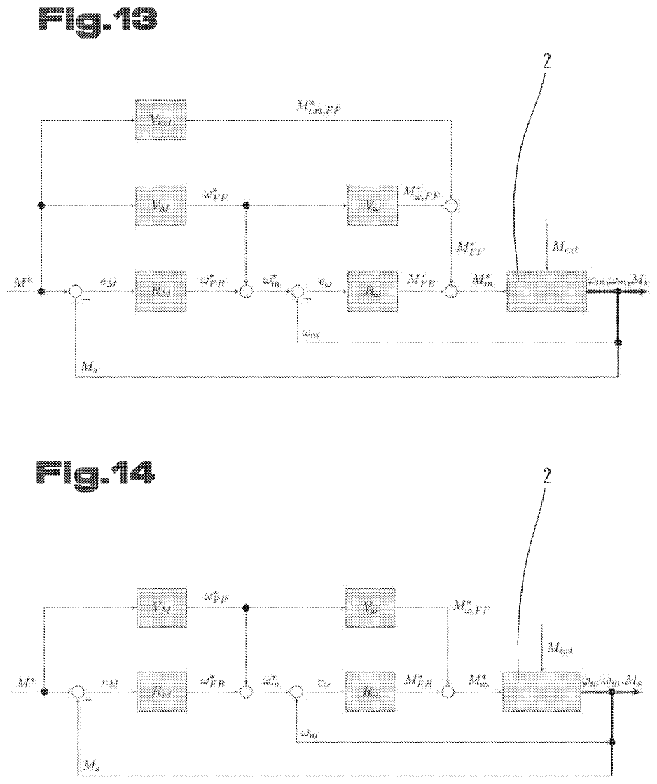

FIG. 13 shows a structural circuit diagram of a regulation circuit with load pilot control, torque pilot control as well as inertia compensation;

FIG. 14 shows a structural circuit diagram of a regulation circuit with torque pilot control as well as inertia compensation;

FIG. 15 shows a structural circuit diagram of a regulation circuit with torque pilot control;

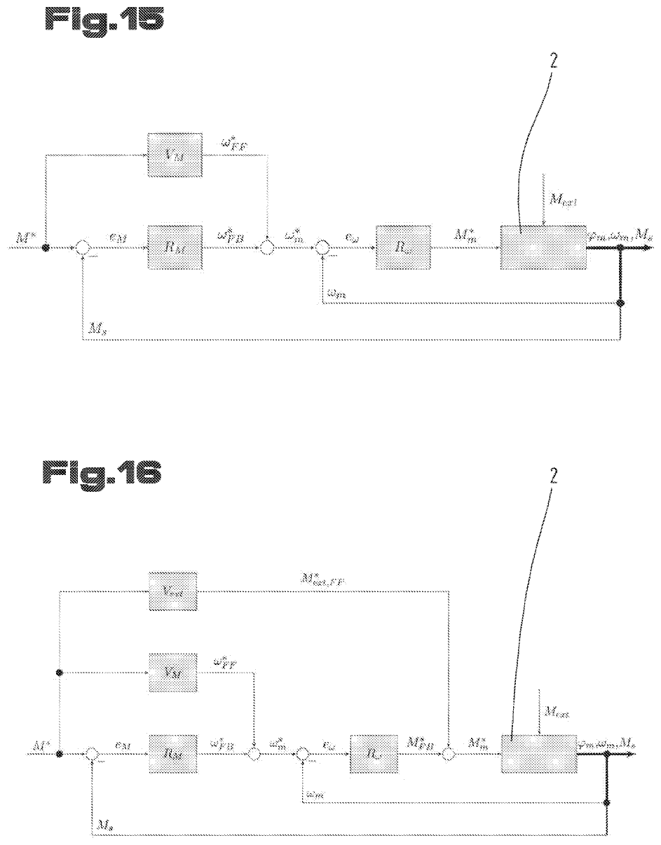

FIG. 16 shows a structural circuit diagram of a regulation circuit with load pilot control as well as torque pilot control.

By way of introduction, it is pointed out that like parts in the differently described embodiments are denoted with like reference symbols or like structural part designations, wherein the disclosures contained in the entire description can be carried over logically to like parts with like reference symbols or like structural-part designations. The position indications chosen in the description, such as top, bottom, side, etc., for example, are also relative to the figure being directly described as well as illustrated, and these position indications are to be logically carried over to the new position upon a position change.

FIG. 1 shows a schematic diagram of a process screwdriver 1. The process screwdriver 1 comprises an electric motor 2 and a screwdriving tool 3 coupled with electric motor 2.

Screwdriving tool 3 may be coupled with a screw 4 or a nut, in order to be able to establish a torque-transmitting connection between the screwdriving tool 3 and the screw 4. Thereby the screw 4 can be driven automatically into a corresponding mating thread 5 of a seating object 6, in order that a structural part 7 can be fixed on the seating object 6.

The screwdriving tool 3 or the screw 4 may have the most diverse forms for force transmission, such as, for example, hexagon, hexagon socket, torx, etc.

Furthermore, it may be provided that the electric motor 2 is designed as a servo motor. As an example, such a servo motor may be a synchronous motor. Moreover, it may be provided that the electric motor 2 is connected to a compensation 8. Furthermore, it may be provided that a frequency converter is formed, which interacts with the electric motor 2 and specifies the rotational speed of the electric motor 2.

As is further apparent from FIG. 1, it may be provided that a gearbox 9 is coupled with the electric motor 2. By means of the gearbox 9, the drive torque or the rotational speed of the electric motor 2 may be stepped up. In particular, it is expedient when the gearbox 9 is configured in such a way that a higher rotational speed is present at the gearbox input 10, which is coupled with a drive shaft 11 of the electric motor 2, than at a gearbox output shaft 12, which is situated at a gearbox output 13 of the gearbox 9.

Furthermore, it is provided that a measuring unit 14, which is designed for sensing the torque present at the screwdriving tool 3, is disposed between electric motor 2 and screwdriving tool 3. The measuring unit 14 is coupled to the regulation 8. The measuring unit 14 is preferably disposed as close as possible to the screwdriving tool 3. As an example, when the process screwdriver 1 comprises a gearbox 9, it is expedient for the measuring unit 14 to be disposed in any case between gearbox 9 and screwdriving tool 3, wherein the measuring unit 14 naturally should be disposed as close as possible to the screwdriving tool 3. Expressed in other words, it is advantageous when the measuring unit 14 is disposed on the gearbox output side 13 of the gearbox 9.

As regards speed of rotation and torque, the gearbox output shaft 12 is coupled directly to the screwdriving tool 3, whereby the gearbox output shaft 12 must move in screwing-in direction 15 for driving the screw 4 into the mating thread 5. In this connection, the screwing-in direction 15 is dependent on the thread orientation of the screw 4. For example, if the screw 4 has a right-hand thread, the screwing-in direction 15 is also rotation to the right. However, if the screw 4 has a left-hand thread, the screwing-in direction 15 is also rotation to the left.

Furthermore, it may be provided that a clutch 16 is provided for connection of electric motor 2 and gearbox 9 or for connection of gearbox 9 and measuring unit 14 or for connection of measuring unit 14 and screwdriving tool 3. The clutch 16 is used in particular for torque transmission between the individual structural parts and is therefore preferably disposed between the individual structural parts. In particular, it may be provided that the screwdriving tool 3 is connected in couplable manner to the drive train. Therefore various screwdriving tools 3 may be used for various screws 4 on the same process screwdriver 1.

Furthermore, it may be provided that a bearing 17 is formed, which is used for absorption of the forces that occur.

The general functional principle of the process screwdriver 1 will now be explained on the basis of FIG. 1.

The screwdriving tool 3 is brought into engagement with the screw 4, and the screw 4 is then driven into the mating thread 5. In a first screwdriving range, the screw 4 is then driven smoothly into the mating thread 5. At the end of this screwdriving process, a shoulder 18 of the screw 4 comes into contact with the structural part 7, whereby the torque for driving the screw increases suddenly. Then the structural part 7 is pressed by the screw 4 toward the seating object 6, wherein the torque increases further, until a predetermined tightening torque is reached.

It may be said that the process of driving of the screw 4 is subdivided into two stages. The first stage is a screwing stage in which the screw 4 is driven freely into the mating thread 5 and the shoulder 18 of the screw 4 does not yet bear on the structural part 7.

The second stage is a tightening stage, in which the shoulder 18 of the screw 4 bears on the structural part 7 and therefore an increased torque must be applied to the screw 4.

In the screwing stage, it may be provided that the electric motor 2 is speed-regulated in higher-level manner until an external threshold value is reached. In the tightening stage, it may be provided that the electric motor 2 is subordinately torque-regulated.

In the tightening stage, a predefined tightening torque may be set by means of a cascaded regulation having two degrees of freedom. This cascaded compensation consists of an internal speed regulation, a higher-level torque regulation and a corresponding model-based pilot control.

By means of the model-based pilot control, an rotational speed is specified such that the variation of the external torque actually acting on the screw 4 is able to follow the specified target trajectory sufficiently accurately. Moreover, this compensation having two degrees of freedom may be expanded by further model-based pilot controls, with which a load and or inertia compensation is achieved. If the mechanical coupling between drive and tool holder is sufficiently stiff, the torque sensed at the measuring unit 14 may be used as a direct feedback variable for the torque regulation. If this is not the case, then the torque sensed at the measuring unit 14 in acceleration phases includes inertial forces due to the inertia of the screwdriving tool.

In order to take this circumstance into account, various workflow or regulation strategies are proposed, which subsequently will be described in still further detail.

For example, it may be provided in a first strategy that, after the occurrence of the torque increase on the basis of the impact of the shoulder 18 on the structural part 7, the electric motor is braked to a minimum speed and this is kept constant until the torque sensed by the measuring unit 14 has settled again at the torque value actually present at the screwdriving tool 3. Starting from this minimum speed, only negligible deviations between the torque sensed at the measuring unit 14 and the torque value actually present at the screwdriving tool 3 occur upon renewed braking, wherewith a regulation of the electric motor 2 to the tightening torque is possible.

In a second strategy, it may be provided that the torque value actually present on the screwdriving tool 3 is estimated with a disturbance-variable monitor and the regulation takes place correspondingly to the estimated value. This disturbance-variable monitor is based on a mathematical model of the process screwdriver 1 as a simulation. Model uncertainties and external disturbances may be compensated by means of an output feedback. In this connection, the disturbance-variable monitor uses the target motor torque, the measured motor rotational speed and the torque sensed at the measuring unit 14 for reconstruction of the torque actually present at the screwdriving tool 3. This estimated load force may then be used as the feedback variable for the torque regulation of the electric motor 2.

The difficulty in the regulation consists in keeping the process speed high and the occurring torques within specified limits. If an ideal, disturbance-free section is assumed, a motor rotational speed variation can be found that makes it possible to set a desired tightening torque. In the real application situation, however, besides the disturbances that occur and the measurement noise, the initial position of the screws 4 is only roughly known, and it varies between different screws 4 by as much as two full turns.

In order to achieve a defined tightening torque and in doing so to keep the process speed as high as possible, the regulation strategies according to the invention have been developed.

As long as the screw turns freely, no substantial increase of the torque actually present at the screwdriving tool 3 is expected. It is therefore logical to directly specify a motor rotational speed profile without additional torque regulation in this screwing phase. Only when the shoulder 18 rests on the structural part 7 does a rapid increase of the torque present on the screwdriving tool 3 occur and does the torque regulation become active. During the screwing stage, a motor rotational speed profile is specified at which different speed levels are uninterruptedly connected to one another. Thereby it is ensured that the mechanical components of the process screwdriver 1 are not unnecessarily stressed and the excitation of vibrations in the system is kept small.

The objective of the regulation is to regulate the torque actually present at the screwdriving tool such that a defined value, also known as tightening torque, is achieved.

The torque actually present at the screwdriving tool 3 is intended to be measured by means of the measuring unit 14 and to be used as a feedback variable during the regulation. However, it must be mentioned that the torque measured in the measuring unit 14 corresponds to the torque actually present at the screwdriving tool 3 only when the screwdriving tool 3 is not being accelerated or braked at that very instant and therefore no dynamic effects are occurring due to the mass inertia of the individual structural parts. Expressed in other words, the torque actually present at the screwdriving tool 3 can be accurately measured by the measuring unit 14 when the screwdriving tool 3 is stationary or is moving at a constant speed of revolution, wherein it is also necessary that this state already last for a certain time period, so that vibrations have already died away.

FIG. 2 shows a flow diagram of a schematic workflow of the first regulation strategy for driving the screw 4.

On the decision path, a plus (+) means the condition is fulfilled. A minus (−) means the condition is not fulfilled.

In method step 1, the drive shaft 11 of the electric motor 2 is accelerated to maximum speed. In order to accelerate the electric motor 2 to maximum speed, a certain time variation of the angular velocity or a certain acceleration ramp may be specified, on the basis of which the electric motor 2 is accelerated. In query A, it is queried whether the drive shaft 11 of the electric motor 2 has already completed a specified number of spindle revolutions. The electric motor 2 is operated at maximum rotational speed until an attainment of the specified number of spindle revolutions leads in query A to a fulfillment of the condition. The number of spindle revolutions that is used at the trigger for the change into the method step 2 is chosen as high as possible, but is chosen so low that, in all cases conceivable on the basis of the tolerances, it is ensured that the shoulder 18 of the screw 4 does not come into contact on the structural part 7 during this method step. During the method step 1, it may be provided that the torque measured at the measuring unit 14 is not queried or at least is not incorporated into the motor regulation.

Then, in method step 2, the electric motor 2 is operated with reduced rotational speed. The reduced rotational speed is used to ensure that, upon the detection of a torque increase in the measuring unit 14, sufficient time remains to reduce the motor rotational speed or to change over to a torque regulation. The speed of rotation at the reduced rotational speed, is dependent on how rapidly the electric motor 2 can be braked and on which angle of rotation the screw 4 can still be turned further after setting of the screw 4 on the structural part 7. For example, when this angle of rotation is very large, the reduced rotational speed may have a high value and be approximately as large as the maximum rotational speed.

The transition from maximum rotational speed to reduced rotational speed may also take place in a manner corresponding to a predetermined time variation of the angular velocity. During the operation of the electric motor 2 at reduced rotational speed, the measuring unit 14 is activated, in order to be able to sense when the shoulder 18 of the screw 4 comes into contact on the structural part 7, whereby a sudden increase of the torque detected in the measuring unit 14 occurs. In inquiry B, it is ascertained whether the torque detected in the measuring unit 14 or its gradient or gradient variation has reached a certain predefined threshold value and whether method step 3 is initiated upon attainment of the threshold value.

In method step 3, the electric motor 2 is operated at a minimum rotational speed. The minimum rotational speed may be different from process to process and will be specified on the basis of the current process parameters. In extreme cases, it may even be necessary for the minimum rotational speed to be equal to zero or to approach zero. The braking from reduced rotational speed to minimum rotational speed should take place as smoothly or abruptly as possible, within the scope of the strength values of the process screwdriver 1. In method step 3, the electric motor 2 is operated at minimum rotational speed until the vibrations occurring due to the abrupt braking maneuver have died away in the drive train. For this purpose, a precalculated time period for dying away of the vibrations is queried in query C.

In an alternative variant, it may also be provided that the necessary time period for dying away of the vibrations is not calculated on the basis of a model but instead it is adapted in an iterative process or that the dying away of the vibrations is observed by sensing of the motor torque in the electric motor 2 in comparison with the measured torque in the measuring unit 14.

When the waiting time is reached, the torque regulation is then activated in the method step 4 and the screw 4 is further tightened under observation of the torque measured in the measuring unit 14.

Corresponding to inquiry D, the screw is tightened until a specified tightening torque is reached. After attainment of this tightening torque, the current screwing process is ended corresponding to the method step 5.

FIG. 3 shows a flow diagram of a schematic workflow of a second regulation strategy for driving the screw 4, wherein the method steps 1 up to and including the query B are the same as already described in FIG. 2. For the sake of brevity, the description of FIG. 3 therefore begins with method step 3, which differs from method step 3 of FIG. 2.

In method step 3, a trajectory-following regulation by means of regulator with two degrees of freedom is activated and the rotational speed of the electric motor 2 is specified by this. During the regulation, the target trajectory is compared with the output of the disturbance-variable monitor. The virtually specified torque, also known as target trajectory, is calculated on the basis of a model of the screw 4. In the process, a torque that is present is assigned in the model calculation to each angle of rotation of the screw. In query C, it is queried whether an end of the time period in which the target trajectory is to be referred to has been reached. If this is the case, the torque measured in the measuring unit 14 is then used in method step 4 as the feedback variable for the regulation and the screw 4 is tightened to the tightening torque.

FIG. 4 illustrates a mechanical model, of the screwdriver with the gearbox 9, that is used as the basis for the mathematical modeling of the screwdriver 44.

For the modeling, the moments of inertia according to the data sheets of the components are sensed and the transitions between the individual components are considered as spring-damper combinations. The values for the spring constants likewise follow from the data sheets of the components being used, while the damping constants are determined empirically. The motor torque Mₘ, against which the friction torques Mᵣₘ of the drive act, forms the input variable of the model. The gearbox is assumed to be lossless and is modeled as a linear spring-mass-damper element. The moment of inertia Θ_{g} of the gearbox is considered together with the motor inertia Θₘ on the drive side. The drive-side motor torque Mₘ acts via the gearbox 9 in a manner reinforced by the gearing factor i_{g}, while the angular position φₘ of the motor is reduced on the takeoff side by the factor 1/i_{g}. The compliance of the gearbox 9 is modeled on the basis of a linear spring with the spring constant c_{g} and a linear damper with the damper constant d_{g}. The angle and the torque between the gearbox 9 and the first clutch 16 are denoted respectively with φ_{g} and M_{g}. The moments of inertia Θₖ of the clutches 16 are counted as halves on each of the drive and takeoff sides and are coupled with one another via a linear element with the spring constant cₖ and the damper constant dₖ. The takeoff-side gearbox torque M_{g} acts on the first clutch 16. The torque on the clutch takeoff side is denoted with Mₖ and the associated angle of rotation with φₖ. By analogy with the clutches, the measuring unit 14 with the moment of inertia Θₛ₁ of the drive side and Θₛ₂ of the takeoff side as well as with the spring-damper element with the spring constant cₛ and the damper constant dₛ is integrated into the drive train. The new angular position and the virtual torque are denoted by φₛ and Mₛ and are present on the drive side of the second clutch 16. This clutch 16 connects the torque sensor with the shaft on which the screwing tool is mounted. The shaft has the moment of inertia Θ_{w}, and the angle of rotation φ_{w} and the torque M_{w} are the variable that are directly present at the screw 4. The friction losses M_{rw} caused by the bearing of the shaft and the external torque Mₑₓₜ of the screw 4 act against this torque. By virtue of the small dimensions, the moment of inertia of the screw 4 is negligible compared with the shaft plus tool.

FIG. 5 shows a simplified model, wherein it is assumed for the simplified structure that the spring constants of the gearbox, of the clutches and of the sensor are interpreted as a series connection and thus can be transformed into the equivalent spring constant

$${c}_{s , r} = \frac{1}{\frac{1}{{c}_{g}} + \frac{2}{{c}_{k}} + \frac{1}{{c}_{S}}} .$$

The sensor, with cₛ, has the smallest stiffness in this series connection, and thereby definitively determines the magnitude of the equivalent spring constant. The equivalent friction d_{s,r} is determined empirically. All moments of inertia of the sensor drive side are transformed taking the step-up ratio on the drive side of the gearbox into consideration and are combined in the moment of inertia

$${θ}_{1} = {θ}_{m} + {θ}_{g} + \frac{{θ}_{k} + {θ}_{S 1}}{{i}_{g}^{2}} .$$

The moment of inertia of the sensor takeoff side is determined by θ₂=θₛ₂+θₖ+θ_{w}. As in the detailed model, the motor torque as well as the external torque is denoted by Mₘ and Mₑₓₜ. The torques M_{rm, r} and M_{rw,r} indicate the torques resulting from the friction losses of the drive and due to the bearing.

FIG. 6 shows an exemplary variation of the external torque over the course of the shaft angle φ_{w}. The exemplary variation of the external torque can be determined by an experiment. This exemplary variation is also known as the load model.

In order to permit a broad field of screwing applications and to ensure the simplicity of the model adaptation, the load model of the specific application situations is determined empirically. The objective is to instrumentally acquire a characteristic that indicates the relationship between the external torque Mₑₓₜ and the screwdriving angle φ_{w}. For this purpose, a screw 4 is driven with constant rotational speed, corresponding to the application situation, until a maximum limit torque is reached on the electric motor 2. By virtue of the constant rotational speed, the measured signal at the measuring unit 14 is in agreement with the externally acting torque. The angular position of the shaft cannot be sensed instrumentally. Therefore the transmission function from the motor angle φₘ to the shaft angle φ_{w} is calculated from the screwdriver model and analyzed in the frequency domain. It has been shown that the transmission function in the relevant frequency range is determined substantially only by the gearing factor i_{g} and so the assumption may be made that φₘ=i_{g}*φ_{w}. Under these circumstances, the relationship between the external torque Mₑₓₜ and the shaft angle φ_{w} can be acquired. A characteristic determined in this way is shown by way of example in FIG. 6. The variation of the characteristic corresponds to that of a nonlinear spring Mₑₓₜ=k(φ_{w})*φ_{w} with the angle-dependent stiffness k(φw).

For the design of the screwing strategies described in FIGS. 2 and 3, the screwing process is subdivided into a screwing stage and a tightening stage. The tightening stage begins with the overshoot of a particular threshold value. If t_{trigger} denotes the point in time for which this overshoot is valid, then a time transformation is defined with tₜᵣₐₙₛ=t−t_{trigger}. In the tightening stage, the torque increase is constant to a first approximation, as is evident from FIG. 6.

FIG. 7 shows a structural circuit diagram of a possible torque regulator R_{M} for torque regulation. The torque regulator R_{M} becomes active as soon as the shoulder 18 of the screw 4 rests on the structural part 7 and the tightening stage begins. On the basis of the assumption of an ideal motor-torque-regulating circuit, the equivalent model of the regulation section can be simplified for the higher-level torque regulator.

This equivalent model is composed of the motor rotational speed regulator and the model of the process screwdriver 1 and is illustrated in detail in FIG. 8. This screwdriver model is subdivided into two separate transmission functions. The transmission function G_{ωm}(s) with Mₘ as the input and ωₘ as the output forms the output feedback for the motor rotational speed regulator R_{ω}(s), whereas the transmission function G_{Ms}(s) from the input Mₘ to the output Mₛ maps the measuring unit 14. The transmission function of the entire regulation section G_{ω}_{ₘ}_{*M}_{ₛ}(s) from the input φₘ* to the output Mₛ is therefore composed of the closed motor rotational speed regulation circuit

$${T}_{ω} ( s ) = \frac{{R}_{ω} ( s )}{1 + {R}_{ω} ( s ) {G}_{ω m} ( s )}$$

and of the sensor transmission function G_{Ms}(s) and can be determined as

$${G}_{{ω}_{m}^{*} , {M}_{s}} ( s ) = \frac{{R}_{ω} ( s )}{1 + {R}_{ω} ( s ) {G}_{ω m} ( s )} {G}_{M s} ( s ) .$$

Various structural circuit diagrams of possible regulation circuits for torque regulation are shown in FIGS. 9 to 15, wherein all figures are based on FIG. 7. To avoid unnecessary repetitions, reference is made to FIG. 7 or to the respective preceding figures.

In the exemplary embodiment according to FIG. 9, it is not the sensor signal Mₛ that is used as the input variable for the torque regulator R_{M}. as is the case in FIG. 7, but instead a torque \hat{M}ₑₓₜ estimated by a disturbance-variable monitor 19 is supplied as the input variable for the torque regulator R_{M}. Furthermore, a torque pilot control V_{M}, a load pilot control Vₑₓₜ and an inertial compensation V_{ω} are provided.

In the exemplary embodiment according to FIG. 10, a torque \hat{M}ₑₓₜ estimated by the disturbance-variable monitor 19 is used as the input variable for the torque regulator R_{M}. Furthermore, a torque pilot control V_{M} and an inertial compensation V_{ω} are provided.

In the exemplary embodiment according to FIG. 11, a torque \hat{M}ₑₓₜ estimated by the disturbance-variable monitor 19 is used as the input variable for the torque regulator R_{M}. Furthermore, a torque pilot control V_{M} is provided.

In the exemplary embodiment according to FIG. 12, a torque \hat{M}ₑₓₜ estimated by the disturbance-variable monitor 19 is used as the input variable for the torque regulator R_{M} are provided. Furthermore, a torque pilot control V_{M} and a load pilot control Vₑₓₜ.

In the exemplary embodiment according to FIG. 13, the sensor signal Mₛ is used as the input variable for the torque regulator R_{M}. Furthermore, a torque pilot control V_{M}, a load pilot control Vₑₓₜ and an inertial compensation V_{ω} are provided.

In the exemplary embodiment according to FIG. 14, the sensor signal Mₛ is used as the input variable for the torque regulator R_{M}. Furthermore, a torque pilot control V_{M} and an inertial compensation V_{ω} are provided.

In the exemplary embodiment according to FIG. 15, the sensor signal Mₛ is used as the input variable for the torque regulator R_{M}. Furthermore, a torque pilot control V_{M} is provided.

In the exemplary embodiment according to FIG. 16, the sensor signal Mₛ is used as the input variable for the torque regulator R_{M}. Furthermore, a torque pilot control V_{M} and a load pilot control Vₑₓₜ are provided.

The exemplary embodiments show possible embodiment variants, wherein it must be noted at this place that the invention is not restricted to the specially illustrated embodiment variants of the same, but to the contrary diverse combinations of the individual embodiment variants with one another are also possible and, on the basis of the teaching of the technical handling by the subject invention, this variation possibility lies within the know-how of the person skilled in the art and active in this technical field.

The scope of protection is defined by the claims. However, the description and the drawings are to be used for interpretation of the claims. Individual features or combinations of features from the shown and described different exemplary embodiments may represent inventive solutions that are independent in themselves. The task underlying the independent inventive solutions may be inferred from the description.

All statements about value ranges in the description of the subject matter are to be understood to the effect that they jointly comprise any desired and all sub-ranges therefrom, e.g. the statement 1 to 10 is to be understood to the effect that all sub-ranges, starting from the lower limit 1 and the upper limit 10 are jointly comprised, i.e. all sub-ranges begin with a lower range of 1 or greater and end at an upper limit of 10 or smaller, e.g. 1 to 1.7, or 3.2 to 8.1, or 5.5 to 10.

Finally, it must be pointed out, as a matter of form, that some elements have been illustrated not to scale and/or enlarged and/or reduced for better understanding of the structure.

### LIST OF REFERENCE NUMERALS

1 Process screwdriver
2 Electric motor
3 Screwdriving tool
4 Screw
5 Mating thread
6 Seating object
7 Structural part
8 Regulation
9 Gearbox
10 Gearbox input
11 Drive shaft
12 Gearbox output shaft
13 Gearbox output
14 Measuring unit
15 Screwing-in direction
16 Clutch
17 Bearing
18 Shoulder
19 Disturbance-variable monitor

1-16. (canceled)

17. A method for driving a screw (4) or nut with a predetermined tightening torque by means of a screwdriving tool (3), which is coupled with an electric motor (2), which is activated by a regulation (8), wherein the method comprises the following method steps:
establishment of a torque-transmitting connection between screwdriving tool (3) and screw (4) or nut;
acceleration of the electric motor (2) in screwing-in direction (15) to a predetermined maximum rotational speed;
operation of the electric motor (2) at maximum rotational speed until a drive shaft (11) of the electric motor (2) has completed a specified number of spindle revolutions, wherein the screw (4) or nut is being driven freely into the respective mating thread (5) during this method step or the mating thread (5) is being cut by means of the screw (4);
reduction of the rotational speed of the electric motor (2) to a predetermined reduced rotational speed;
operation of the electric motor (2) at reduced rotational speed until a torque increase that exceeds a predetermined threshold value is detected, wherein the torque increase occurs when the screw (4) or nut comes to contact with its shoulder (18) on the structural part (7) to be fastened;
subsequent turning of the screw (4) or nut until the predetermined tightening torque is reached;
wherein the torque increase is detected by a measuring unit (14) connected downstream from the electric motor (2); and
wherein, directly after the detection of the torque increase, the further activation of the electric motor (2) by the regulation (8) is specified on the basis of a torque value, wherein the electric motor (2) is braked to a predetermined minimum rotational speed after the detection of the torque increase and, in an initial period during the braking process, the torque sensed in the measuring unit (14) is cross-faded by a target-trajectory torque based on a model calculation and, after the initial period, the torque detected by the measuring unit (14) is used as the input variable for the regulation (8).

18. The method according to claim 17, wherein the electric motor (2) is braked to a predetermined minimum rotational speed after the detection of the torque increase.

19. The method according to claim 18, wherein the electric motor (2) is operated at minimum rotational speed for a predetermined or predeterminable time period, until vibrations that occur in the drive system due to the process of braking from the reduced rotational speed to the minimum rotational speed have largely died away.

20. The method according to claim 17, wherein the reduced rotational speed amounts to between 0.1% and 99%, especially between 0.5% and 99%, preferably between 50% and 80% of the maximum rotational speed.

21. The method according to claim 17, wherein, directly after the detection of the torque increase, the further activation of the electric motor (2) is specified by the regulation (8) on the basis of a target trajectory of the torque value, wherein the rotational speed variation is calculated from the target trajectory of the torque value in a pilot control.

22. The method according to claim 21, wherein, in a first phase after the detection of the torque increase, the torque value is estimated by means of a disturbance-variable monitor (19) and, in a second phase after detection of the torque increase, the torque value is detected directly by the measuring unit (14) and used as the input variable for the regulation (8).

23. The method according to claim 17, wherein the transition between various rotational speeds of the individual method steps is specified in such a way that no sudden increases of the acceleration occur.

24. The method according to claim 17, wherein, in the model calculation of the process screwdriver (1), the mass inertia and/or the spring stiffness and/or the damping and the angular accelerations of the individual structural parts (7) built into the drive train are taken into consideration.

25. The method according to claim 17, wherein the model calculation is adapted on the basis of the respective preceding cycles in an iterative learning process, wherein the time variation of the measured value of the torque in the measuring unit (14) as well as of the motor torque and of the associated angle of rotation of the drive shaft (11) in the electric motor (2) is used for adaptation of the model calculation.

26. The method according to claim 17, wherein a disturbance-value monitor (19), especially a Kalman filter, is used for cross-fading of model calculation and torque detected in the measuring unit (14).

27. The method according to claim 26, wherein a cross-fading takes place between the torque, estimated in the disturbance-variable monitor (19), actually acting on the screw (4), and the torque sensed in the measuring unit (14).

28. The method according to claim 17, wherein a gearbox (9), by means of which the rotational speed or the torque between electric motor (2) and screwdriving tool (3) is stepped up, is disposed between electric motor (2) and screwdriving tool (3).

29. The method according to claim 17, wherein the trajectory planning takes place on the basis of a load model, which is determined empirically.

30. A method for driving a screw (4) or nut with a predetermined tightening torque by means of a screwdriving tool (3), which is coupled with an electric motor (2), which is activated by a regulation (8), wherein the method comprises the following method steps:
establishment of a torque-transmitting connection between screwdriving tool (3) and screw (4) or nut;
acceleration of the electric motor (2) in screwing-in direction (15) to a predetermined maximum rotational speed;
operation of the electric motor (2) at maximum rotational speed until a drive shaft (11) of the electric motor (2) has completed a specified number of spindle revolutions, wherein the screw (4) or nut is being driven freely into the respective mating thread (5) during this method step or the mating thread (5) is being cut by means of the screw (4);
reduction of the rotational speed of the electric motor (2) to a predetermined reduced rotational speed;
operation of the electric motor (2) at reduced rotational speed until a torque increase that exceeds a predetermined threshold value is detected, wherein the torque increase occurs when the screw (4) or nut comes to contact with its shoulder (18) on the structural part (7) to be fastened;
subsequent turning of the screw (4) or nut until the predetermined tightening torque is reached;
wherein the torque increase is detected by a measuring unit (14) connected downstream from the electric motor (2) and in wherein the electric motor (2) is braked to a predetermined minimum rotational speed after the detection of the torque increase, wherein the electric motor (2) is operated at minimum rotational speed for a predetermined or predeterminable time period, until vibrations that occur in the drive system due to the process of braking from the reduced rotational speed to the minimum rotational speed have largely died away and, after passage of the predetermined time period during which the electric motor (2) is operated at minimum speed, the further activation of the electric motor (2) is specified by the regulation (8) on the basis of the torque measured in the measuring unit (14).

31. A method for driving a screw (4) or nut with a predetermined tightening torque by means of a screwdriving tool (3), which is coupled with an electric motor (2), which is activated by a regulation (8), wherein the method comprises the following method steps:
establishment of a torque-transmitting connection between screwdriving tool (3) and screw (4) or nut;
acceleration of the electric motor (2) in screwing-in direction (15) to a predetermined maximum rotational speed;
operation of the electric motor (2) at maximum rotational speed until a drive shaft (11) of the electric motor (2) has completed a specified number of spindle revolutions, wherein the screw (4) or nut is being driven freely into the respective mating thread (5) during this method step or the mating thread (5) is being cut by means of the screw (4);
reduction of the rotational speed of the electric motor (2) to a predetermined reduced rotational speed;
operation of the electric motor (2) at reduced rotational speed until a torque increase that exceeds a predetermined threshold value is detected, wherein the torque increase occurs when the screw (4) or nut comes to contact with its shoulder (18) on the structural part (7) to be fastened;
subsequent turning of the screw (4) or nut until the predetermined tightening torque is reached;
wherein the torque increase is detected by a measuring unit (14) connected downstream from the electric motor (2) and in wherein, directly after the detection of the torque increase, the further activation of the electric motor (2) is specified by the regulation (8) on the basis of a target trajectory of the torque value, wherein the rotational speed variation is calculated from the target trajectory of the torque value in a pilot control, wherein, in a first phase after the detection of the torque increase, the torque value is estimated by means of a disturbance-variable monitor (19) and, in a second phase after detection of the torque increase, the torque value is detected directly by the measuring unit (14) and used as the input variable for the regulation (8).
